(19) United States
(12) Patent Application Publication
(10) Pub. No.: US 2012/0053762 A1
(43) Pub. Date: Mar. 1, 2012

(54) INCEPTOR SYSTEM AND APPARATUS FOR GENERATING A VIRTUAL REAL-TIME MODEL

(75) Inventors: Matthias Stiefenhofer, Lindenberg (DE); Matthias Ludwig, Lindenberg (DE); Michael Rottach, Sulzberg (DE); Ralph Neumann, Scheidegg (DE); Manfred Schlosser, Lindenberg (DE)

(73) Assignee: Liebherr-Aerospace Lindenberg GmbH, Lindenberg (DE)

(21) Appl. No.: 13/218,633

(22) Filed: Aug. 26, 2011

(30) Foreign Application Priority Data
Aug. 30, 2010 (DE) 102010035825.8

(51) Int. Cl. G06F 17/00

(52) U.S. Cl. 701/3

(57) ABSTRACT

The present invention relates to an active inceptor system for controlling an aircraft with at least one mechanically movable inceptor, at least one controller for actuating the inceptor, and at least one state variable detection means for detecting one or more state variables of the one or more inceptors, wherein the active inceptor system comprises at least one means for generating a virtual real-time model for modelling the real flight component, in particular the one or more inceptors.

### BACKGROUND OF THE INVENTION

This invention relates to an active inceptor system for controlling an aircraft with at least one mechanically movable inceptor, a controller for controlling the inceptor actuation, and at least one state variable detection means for detecting one or more state variables of the one or more inceptors.

Such control stick systems generally employ a control stick mechanically movable about a plurality of axes, which can be actuated by the pilot for flight control of the aircraft. The inclination of the control stick about one of the axes for example influences the longitudinal and/or transverse inclination of an airplane or the pitch and roll movement as well as the vertical movement of a helicopter. In contrast to the classical control, in which the control movements of the pilot are transmitted to the controlling actuating devices of the aircraft by steel cables, push rods or other hydraulic systems, the variable actuating position of the mechanically movable control stick is detected by associated sensors and transmitted to the corresponding actuating devices of the aircraft via electric lines.

In a classical control stick design the forces which act on the airplane during the flight are transmitted to the control unit in the form of resistance and deflection. In the design of the fly-by-wire system with passive control stick system there is no such feedback. In particular in aviation engineering, the haptic transmission of information of the control system often is of great advantage for the pilots.

Active control systems provide for simulating the occurring control forces and adapt the same to the respective flight situation, so as to achieve an optimum support of the pilot. The feedback for example is transmitted to the control device in the form of movements or signals, whereby an intuitive reaction of the pilot to the respective flight situation is facilitated. Furthermore, the pilot gets a precise feedback on the control inputs made by him. Even when using an electric control system, it is therefore possible for the pilot to feel the behavior of the aircraft during the flight operation.

Possibly, it can occur that certain state variables of the inceptor or of the actuators for actuating the inceptor can only be measured with great effort, too imprecisely or not at all. For a satisfactory control of the active inceptor system, in particular for a feel generation close to reality, especially these state variables in general are not absolutely necessary or urgently desired. The non-consideration instead leads to disadvantageous control inaccuracies.

### SUMMARY OF THE INVENTION

It is the object of the present invention to disclose an inceptor system for aircraft, which comprises measures for avoiding the above-mentioned problems.

This object is solved by an active inceptor system according to the features herein. Further advantageous embodiments of the inceptor system are subject-matter herein.

Accordingly, an active inceptor system for controlling an aircraft comprises at least one mechanically movable inceptor, at least one controller for controlling the inceptor actuation, and at least one state variable detection means for detecting one or more state variables of the inceptor system or the inceptor.

The movable inceptor is designed to be freely movable about an arbitrary number of axes and serves for the control command input of the pilot. The involvement of the inceptor is based on the known fly-by-wire technology, which provides a forwarding of the control inputs of the pilot detected by means of the state variable detection means via a signal line to the corresponding actuators of the airplane. The respective designs of the inceptor can be chosen as desired, but will not be described in detail below.

The state variables can be divided into variables for describing the inceptor and into variables for describing the control elements or actuators of the inceptor. The state variables for example cover position, speed, acceleration or force variables. In principle, however, arbitrary variables can be covered thereby.

The architecture of the active inceptor system according to the invention includes at least one means for generating a virtual real-time model or alternatively is directly/indirectly connected or connectable with this means. The virtual real-time model simulates the real flight component in a model in real time. Real flight component is understood to be the one or more inceptors or other components of the active inceptor system. Influences, forces or movements which act on the inceptor or are caused by the same can be simulated at the running time with reference to the virtual real-time model.

The virtual real-time model provides the basis for realizing numerous advantageous functions within the active inceptor system. These include for example control and regulation tasks as well as monitoring tasks and the implementation of necessary redundancies of the system.

Advantageously, one or more state variables can be supplied to the virtual real-time model by the state variable detection means. Generating the real-time model is effected on the basis of the supplied state variables of the mechanically movable inceptor and/or of the state variables of the one or more actuators or control elements.

An essential advantage of the active inceptor system according to the invention consists in that by means of the virtual real-time model one or more state variables can be derived or calculated from one or more initially present state variables. For the sake of simplicity, the derived/calculated state variables will subsequently be referred to as virtual state variables. Accordingly, the virtual real-time model allows to reconstruct non-measurable variables by using the known input variables or state variables. Of course, the required number of measuring sensors, i.e. detection means, can be reduced thereby.

In particular, it can be provided that the active inceptor system according to the invention does without a real force measurement at the mechanically movable inceptor or actuator and instead simulates/calculates the force state variable by means of the virtual real-time model. It is also conceivable that a position state variable and/or a speed state variable and/or acceleration variable or the like can be derived/calculated by the inceptor model from arbitrary input variables. It basically applies that by means of the virtual real-time model each further state variable can be replaced by using other state variables.

Advantageously, inner and/or outer state variables can be supplied to the virtual real-time model. The outer state variables possibly include signals of an autopilot or other signals of the aircraft which do not or at least only indirectly concern the active inceptor system of the aircraft The calculation of arbitrary state variables on the basis of the virtual real-time model preferably is effected in consideration of outer state variables.

In a particularly advantageous embodiment of the invention, the active inceptor system comprises at least one feel generating means for generating or influencing at least one setpoint variable for at least one controller of the inceptor actuation. For example, one or more state variables can be transmitted from the feel generating means to the virtual real-time model.

The inceptor actuation comprises at least one control element or at least one electric actuator which in particular is designed as electric motor or the like and whose drive shaft is directly or indirectly connected with the inceptor via a transmission arrangement. In particular for each axis of movement of the inceptor at least one control element or actuator can be provided. The feel generation caused by the feel generating means preferably can be applied to each axis of an inceptor designed as side stick.

At least one controller of the active inceptor according to the invention preferably is designed as movement controller, in particular as position controller and/or speed controller and/or acceleration controller. Alternatively or in addition, a force controller can also be provided.

It is conceivable that the virtual real-time model according to the invention determines one or more virtual auxiliary variables from one or more incoming state variables. The virtual auxiliary variables preferably can be interpreted as virtual setpoint variables which can directly be supplied to at least one of the controllers of the inceptor system. Alternatively or in addition, one or more virtual auxiliary variables can be transmitted to the feel generating means. One or more virtual auxiliary variables preferably comprise a movement setpoint variable, in particular a speed setpoint variable and/or a position setpoint variable and/or an acceleration setpoint variable and/or a force setpoint variable.

As has already been explained above, a corresponding controller actuation for feedback generation at the inceptor can be generated by means of the feel generating means. The provided controller actuates at least one control element/actuator for mechanically actuating the inceptor.

In a particularly preferred aspect of the invention the generation of the virtual real-time model is effected on the basis of the known Luenberger model. Alternatively, the virtual inceptor model can be realized on the basis of a Kalman filter or on the basis of neural networks.

To be able to react to disturbances or its own inaccuracies, the active inceptor system preferably comprises means for matching the virtual real-time model with the state of the real flight component, in particular with the one or more movable inceptors. In this way, deviations between measured variable and virtual variable can be detected and minimized. In particular, real state variables detected by the state variable detection means are matched with the virtually generated state variables. The difference preferably can be fed back to the virtual inceptor model. Accordingly, a matching of the virtual inceptor model is effected by means of one or more measurable state variables with respect to the real flight component of the active inceptor system. Malfunctions of certain components of the system, in particular of the state detection means, can be detected at the running time.

Matching preferably is effected in real time with variable scanning.

In one embodiment of the invention, the controller of the active inceptor system is designed as movement controller, in particular as position controller. Under these circumstances, the feel generating means serves for generating a movement setpoint variable which is directly or indirectly provided to the movement controller. Alternatively or in addition, at least one virtual movement setpoint variable can be generated by the virtual real-time model, which is provided either to the feel generating means and/or to the movement controller. The feel generating means is not absolutely necessary for the controller actuation, and instead the same can completely be accomplished by the virtual real-time model.

Advantageously, one or more movement axes of the inceptor can be simulated or controlled and/or monitored by the virtual real-time model. If the mechanically movable inceptor comprises one or more movement axes which can be controlled by the feel generating means or the controller, it is expedient that the movement axes can at least partly be simulated by the virtual inceptor model.

As has already been explained in detail above, the virtual real-time model expediently serves for providing virtual auxiliary variables, in particular for providing virtual setpoint variables for influencing the controller architecture of the active inceptor system. Alternatively or in combination with the control function a monitoring function of the virtual inceptor model is conceivable. The virtually generated model serves for monitoring the function of the active inceptor system, in particular for monitoring the measured state variables or the corresponding controller actuation.

Furthermore, the use of the virtual inceptor model is possible for reasons of redundancy.

The invention furthermore is directed to an apparatus for generating a virtual real-time model for simulating a real flight component of an aircraft. In accordance with the invention, the apparatus is suitable for use in an active inceptor system according to one of the foregoing advantageous embodiments, so that quite obviously the same advantages and properties can be obtained. A repeated explanation therefore is omitted at this point.

Furthermore, the invention relates to an aircraft with at least one active inceptor system according to the invention.

### BRIEF DESCRIPTION OF THE DRAWINGS

Further advantages and details of the invention will be explained in detail with reference to an exemplary embodiment illustrated in the drawing, in which:

FIG. 1: shows a block circuit diagram of the active inceptor system according to the invention, and

FIG. 2: shows a schematic representation of the virtual inceptor model.

### DESCRIPTION OF THE PREFERRED EMBODIMENTS

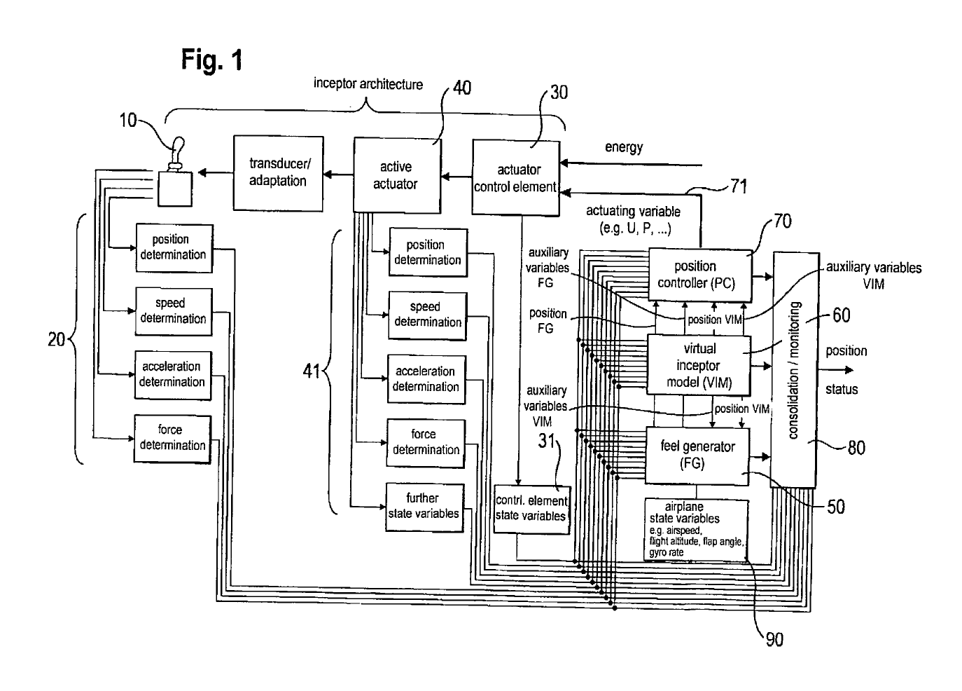

FIG. 1 shows a block circuit diagram of the active inceptor system according to the invention. The architecture comprises a mechanically movable inceptor in the form of a control stick 10 which is mechanically connected with at least one control element 30 or at least one active actuator 40. The actuator 40 preferably is designed as electric motor whose drive shaft causes a mechanical force acting on the control stick 10 via a transmission structure and generates a control stick movement. Since the control stick 10 is freely movable about an arbitrary number of axes, one control element 30 or actuator 40 is provided per axis.

The architecture furthermore comprises detection means 20 which are arranged at the stick mechanism and serve for determining the current actuating position of the control stick 10. Parameters such as the speed, acceleration and force, which occur upon actuation of the control stick 10, can be determined by these detection means 20. Further sensors (detection means) determine the current state variables 31, 41 of the used actuators 40 or control elements 30 for moving the control stick 10.

For generating the electronically controlled feedback in dependence on the control stick actuation the feel generating means 50 is used. At the input of the feel generating means 50 the signals of the internal state variables 20, 31, 41 generated by the sensors are present. Furthermore, the position controller 70 makes use of said signal lines of the sensors on the input side.

For considering the current flight position of the aircraft external state variables 90 furthermore are detected by external sensor systems and forwarded to the feel generating means 50. The external state variables 90 for example include the current airspeed, the flight altitude, the set flap angle and the measurement data of the gyroscopes used in the airplane and corresponding signals of the autopilot.

The virtual inceptor model 60, i.e. the virtual real-time model, generally is based on a mathematical model which simulates a virtual control stick. In consideration of the state variables 20, 31, 41 the inceptor model 60 generates a plurality of simulation values which comprise a virtual position as well as further auxiliary variables of the control stick 10. The simulation date are supplied to the position controller 70 and to the feel generating means 50.

By using a virtual inceptor model 60, a force measurement or a force control theoretically can be omitted completely.

From the supplied state variables 20, 31, 41 of the sensors, the virtual state and auxiliary variables of the virtual inceptor model 60 and the external state variables 90 the feel generating means 50 generates a desired position for the control stick 10. The desired position can be generated by using a stored characteristic curve or a feel model, wherein different behavioral characteristics are ascribed to the characteristic curves or the models. By way of example the use of a spring-mass model or an arbitrary force-position characteristic curve should be mentioned, which in dependence on an incoming force state variable determines a predefined desired position for the control stick 10. Further embodiments employ an attenuation speed characteristic curve or simulate a detend and/or break-out and/or position limitation and/or soft stop function and/or a friction model and/or a force or position offset and/or a force and/or speed limitation.

At the actual input of the position controller 70 the state variables 20, 31, 41 of the inceptor 10 and of the actuators 40 are present. Taking into account the desired position generated by the feel generating means 50 as well as the virtual auxiliary variables, a corresponding actuating variable 71 is generated for the control elements 30 of the inceptor architecture. The actuating variable 71 includes e.g. arbitrary control voltages, control currents as well as other control variables for the motor or control element actuation.

For safety reasons, the control stick system comprises a consolidation or monitoring means 80 which monitors the generated variables of the position controller 70 and of the feel generating means 50 and the virtual inceptor model 60 and possibly subjects the same to a plausibility check. The respective data of the monitoring or consolidation means 80 optionally are output acoustically via a display element or optically as status message.

The feel generation at the mechanically movable control stick 10 can easily be generated with reference to a position control. Furthermore, the state variable force can be replaced by a state variable torque.

Since an aircraft often is equipped with a plurality of control stick systems for reasons of redundancy, a coupling between the used systems must be effected. The communication between the two systems is realized by means of an electric connection. Status messages of the monitoring or consolidation means or the used state variables of the actuators and of the control sticks for example are exchanged between the control architectures of the coupled systems.

Alternatively, a plurality of control sticks or control stick systems is used not for redundancy reasons, but for realizing various control tasks. For example, a side stick serves for executing roll and pitch movements of a helicopter, whereas a second side stick controls the vertical movement. Here as well, a synchronized feel generation and the exchange of various status messages and state variables is absolutely necessary on both sticks.

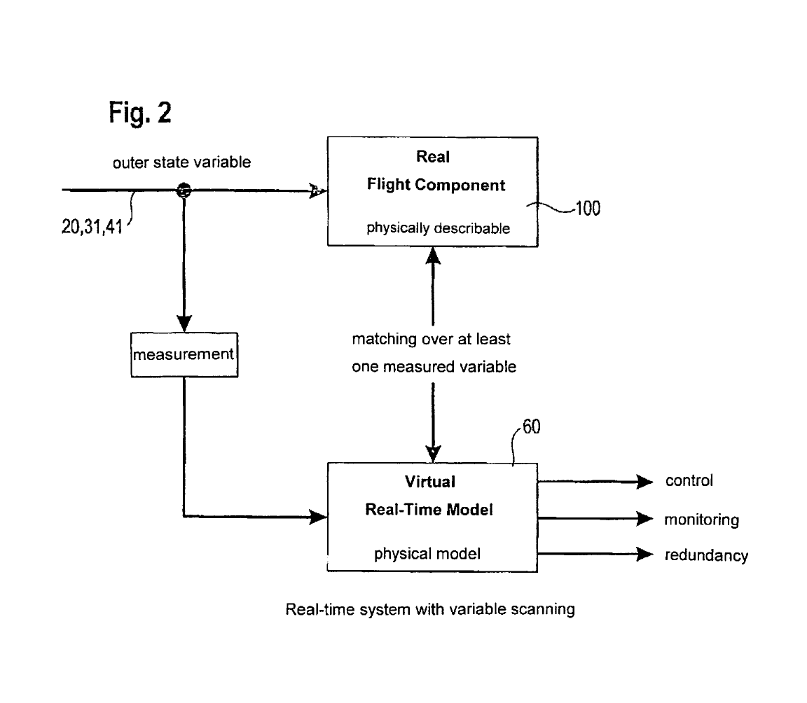

FIG. 2 shows a schematic representation of the architecture of the virtual inceptor model. The representation shows the coarse division of the architecture of the active inceptor system into a real flight component 100 and into a virtual real-time model 60.

The real flight component 100 substantially comprises the feel generating means 50 and the corresponding control path 70 for feel generation to the mechanically movable inceptor 10.

Both inner and outer state variables 20, 31, 41, 90 are supplied to the real flight component 100. The inner state variables 20, 31, 41 characterize the state of the mechanically movable inceptor 10 or the state of the actuators 40 or control elements 30 and generally are metrologically detected by the sensors and state variable detection means provided for this purpose. The outer state variables 90 include arbitrary data or measured values which should be incorporated in the control architecture.

Furthermore, these state variables 20, 31, 41, 90 are at least partly supplied to the virtual real-time model 60. This component 60 virtually simulates the state of the mechanically movable inceptor 10. The simulation for example is performed by using the Luenberger model. Alternatively or in combination, further theories such as for example a Kalman filter or a neural network can be applied. Due to the mapping of the real flight component 100 by the virtual real-time model 60, arbitrary state variables can be determined for characterizing the real flight component 100.

This provides the essential advantage that in addition to the state variables 20, 31, 41 detected by the sensors further arbitrary state variables can also be determined without a corresponding measuring arrangement.

To exclude or minimize possible disturbing influences or inaccuracies of the virtual real-time model 60, a matching between the real flight component 100 and the virtual real-time model 60 is effected. The matching in particular supplies the difference value between a measured state variable and a virtual state variable generated by means of a virtual real-time model 60.

As is already indicated with reference to FIG. 2, the initial values of the virtual realtime model 60 can be employed for certain fields of application. The generated auxiliary variables, in particular the generated virtual state variables can either be used, as already explained above, for the control of the active inceptor system. Alternatively or in addition, the virtual real-time model can be used as an independent monitoring instance, whereby the measurement of the state variables and/or the generation of the setpoint variables for the control architecture of the real flight component 100 are monitored.

What is likewise possible is the use of the virtual real-time model for creating a redundant active inceptor system.

1. An active inceptor system for controlling an aircraft with at least one mechanically movable inceptor, at least one controller for actuating the inceptor and at least one state variable detection means for detecting one or more state variables of the one or more inceptors, wherein the active inceptor system comprises at least one means for generating a virtual real-time model for modelling the real flight component, in particular the one or more inceptors.

2. The active inceptor system according to claim 1, wherein one or more state variables can be supplied to the virtual real-time model by the state variable detection means.

3. The active inceptor system according to claim 1, wherein the virtual real-time model comprises means for calculating one or more state variables from one or more initially present state variables.

4. The active inceptor system according to claim 1, wherein at least one feel generating means is provided for generating or influencing at least one setpoint variable for at least one controller.

5. The active inceptor system according to claim 1, wherein the virtual real-time model determines or calculates one or more virtual auxiliary variables, in particular virtual setpoint variables, from one or more incoming state variables, and the virtual auxiliary variables can be transmitted to at least one controller and/or to the feel generating means.

6. The active inceptor system according to claim 1, wherein the virtual real-time model is based on the Luenberger model and/or on a Kalman filter and/or a neural network.

7. The active inceptor system according to claim 1, wherein means for matching the virtual real-time model with the state of the real flight component, in particular the movable inceptor, are provided.

8. The active inceptor system according to claim 7, wherein the matching is effected in real time with variable scanning.

9. The active inceptor system according to claim 1, wherein the virtual real-time model is designed for monitoring the real flight component and/or as redundancy to the real flight component.

10. The active inceptor system according to claim 1, wherein at least one controller is a position controller.

11. The active inceptor system according to claim 1, wherein one or more movement axes of the mechanically movable inceptor can be simulated by the virtual real-time model and be controlled by at least one controller, and wherein the control possibly can be influenced by the feel generating means.

12. The active inceptor system according to claim 1, wherein inner and/or outer state variables can be supplied to the virtual real-time model and possibly to the feel generating means.

13. An apparatus for generating a virtual real-time model of a real flight component for an active inceptor system according to claim 1.

14. An aircraft with an active inceptor system according to claim 1.

15. The active inceptor system according to claim 2, wherein the virtual real-time model comprises means for calculating one or more state variables from one or more initially present state variables.

16. The active inceptor system according to claim 15, wherein at least one feel generating means is provided for generating or influencing at least one setpoint variable for at least one controller.

17. The active inceptor system according to claim 3, wherein at least one feel generating means is provided for generating or influencing at least one setpoint variable for at least one controller.

18. The active inceptor system according to claim 2, wherein at least one feel generating means is provided for generating or influencing at least one setpoint variable for at least one controller.

19. The active inceptor system according to claim 16, wherein the virtual real-time model determines or calculates one or more virtual auxiliary variables, in particular virtual setpoint variables, from one or more incoming state variables, and the virtual auxiliary variables can be transmitted to at least one controller and/or to the feel generating means.

20. The active inceptor system according to claim 17, wherein the virtual real-time model determines or calculates one or more virtual auxiliary variables, in particular virtual setpoint variables, from one or more incoming state variables, and the virtual auxiliary variables can be transmitted to at least one controller and/or to the feel generating means.
